(19) United States
(12) Patent Application Publication
(10) Pub. No.: US 2008/0092172 A1
(43) Pub. Date: Apr. 17, 2008

(54) Method and apparatus for a zooming feature for mobile video service

(76) Inventors: Katherine H. Guo, Scotch Plains, NJ (US); Arun N. Netravali, Westfield, NJ (US); Krishan K. Sabnani, Westfield, NJ (US)

Correspondence Address: Lucent Technologies Inc.;Docket Administrator - Room 3J-219, 101 Crawfords Corner Road, Holmdel, NJ, 07733-3030, US

(21) Appl. No.: 11/540,228

(22) Filed: Sep. 29, 2006

(51) Int. Cl. H04N 5/445; G06F 13/00; H04N 7/16; G06F 3/00; G06F 3/048; H04N 7/173

(52) U.S. Cl. 725/47; 725/62; 725/37; 725/38; 715/779; 725/112; 725/110; 725/113

(57) ABSTRACT

The new zooming feature of the present invention applies to video service on mobile phones. The feature offers more interaction between the end user and the video server and it provides more interesting viewing. It has the potential to become a service differentiator for video services provided by wireless service providers. Because the bandwidth required for the streams does not change, the only complexity incurred is the control message processing and the only extra storage required is at the video server or the proxy.

### TECHNICAL FIELD

This invention relates generally to the field of wireless telecommunications and in particular to television services provided to wireless devices.

### BACKGROUND OF THE INVENTION

As broadband service providers are in the race to provide “triple play” service of voice, data and video, wireless service providers are also in the race to provide TV programs to mobile phones in order to complete the “mobile triple play” of phone, Internet and TV service. Today's mobile phones have integrated a large number of other features such as web browser, Personal Digital Assistant (PDA), MP3 player, AM/FM radio receiver, Global Positioning System (GPS), camera, game console etc. However, providing TV service to mobile phones such as live TV and Video on Demand (VoD) is only at the beginning stage.

A number of wireless service providers are offering mobile TV service today using existing 3G unicast channels. Verizon offers VCAST service. It is a download-then-play service for short clips offered using 3G unicast channels in CDMA2000 packet data or CDMA Evolution Data Only (EvDO) networks. Sprint offers a 13-channel MobiTV service using 3G unicast channels in CDMA2000 packet data network. Other companies such as Cingular, KDDI, SK Telecom and T-Mobile also offer mobile TV service using 3G unicast channels in existing 3G packet data or circuit data networks.

Unicast is best suited for offering individual clips to different receivers. However, it is not scalable. Broadcast/multicast is an efficient means of transmitting the same content to multiple receivers while minimizing network resource usage. Live TV programs can be delivered efficiently to mobile users using broadcast multicast services. Two types of multicast broadcast networks are under development, namely 3G networks and Orthogonal Frequency Division Multiplexing (OFDM)-based networks such as Digital Video Broadcast-Handheld (DVB-H), Digital Multimedia Broadcasting (DMB), and Forward Link Only (FLO) based on QUALCOMM's popular CDMA technology.

Video content delivery methods can be divided into three categories, “download-and-play”, “progressive download” and “streaming”. With download-and-play, video content is sent and stored on the end user device in its entirety before viewing can take place. It is used for non real-time content only. With progressive download, after a percentage of the content is downloaded, the end user can start viewing while at the same time the rest of the content is downloaded. This methodology can be used for real-time content with some delay. Finally, with streaming delivery, the content is streamed to the end user device, but never stored there. The user must view the content as the end device receives the stream. Streaming is the best method for real-time service.

Streaming can be used for live content and stored content. With live content, the end user does not have much control because the content is generated in real-time. However, for stored content, such as Video on Demand (VoD), because of the real-time nature of streaming video, end users can actively control what content is being played back. For example VCR operations such as pause, resume, fast-forward, rewind, stop etc are supported in Real Time Streaming Protocol (RTSP), the IETF standard protocol for controlling multimedia streams. In addition to the above-mentioned features, a need exists for further user-controlled features in order to enhance the mobile TV viewing experience.

### SUMMARY OF THE INVENTION

An advance is made over the prior art in accordance with the principles of the present invention that is directed to providing zooming features to a mobile device capable of displaying TV programming. One embodiment of the invention sets forth a method comprising the steps of receiving an indication of a reference point for a new view request at a server based on coordinates of a current view of the programming. The server also receives an indication of the resolution for the new view. The server then provides an altered view of said programming to said mobile device based on said received reference point and relative resolution.

A mobile apparatus for providing zooming features related to TV programming being received thereon is also described. The apparatus includes a processor for providing capability to display the TV programming being received. A GUI is included at the mobile apparatus for displaying information related to operation of the zooming features and enabling transmitting information from said mobile apparatus related to said zooming features. The mobile apparatus is operable to transmit an indication of a reference point for a new view request based on coordinates of a current view of said programming and is further operable to transmit an indication of the resolution for said new view, wherein said device receives an altered view of said programming based on said received reference point and relative resolution.

### BRIEF DESCRIPTION OF THE DRAWING

The teachings of the present invention can be readily understood by considering the following detailed description in conjunction with the accompanying drawings, in which:

FIG. 1 shows an exemplary communications network architecture for providing the zooming feature for mobile video services in accordance with the present invention; and

FIG. 2 is an exemplary GUI for enabling the zooming feature in accordance with the invention.

### DETAILED DESCRIPTION

An exemplary embodiment of the invention will now be described while referring to the figures, several of which may be simultaneously referred to during the course of the following description.

Today's VoD streaming services typically use unicast communication channels as the transport mechanism and use RTSP (Real Time Streaming Protocol) as the control protocol. Thus, user interactivity features are limited to VCR-type operations supported by RTSP.

Given the typically small size of mobile phone screens, it may be difficult to display a large view with enough details for certain types of programming. In some scenarios, different viewers may prefer to view different portions of a video frame with greater detail. For example, when viewing a sports program, such as a baseball game, the camera at times captures the entire field. Some viewers, however, may want to see the facial expressions of their favorite player or players, if possible, instead of the view of the field. Each person's viewing preference is thus different, and the close up view offered by the camera may not satisfy every viewer's desire.

The present invention sets forth a novel interactive zooming feature for streaming video, where end users can issue commands in order to receive a close-up view of a portion of the current view.

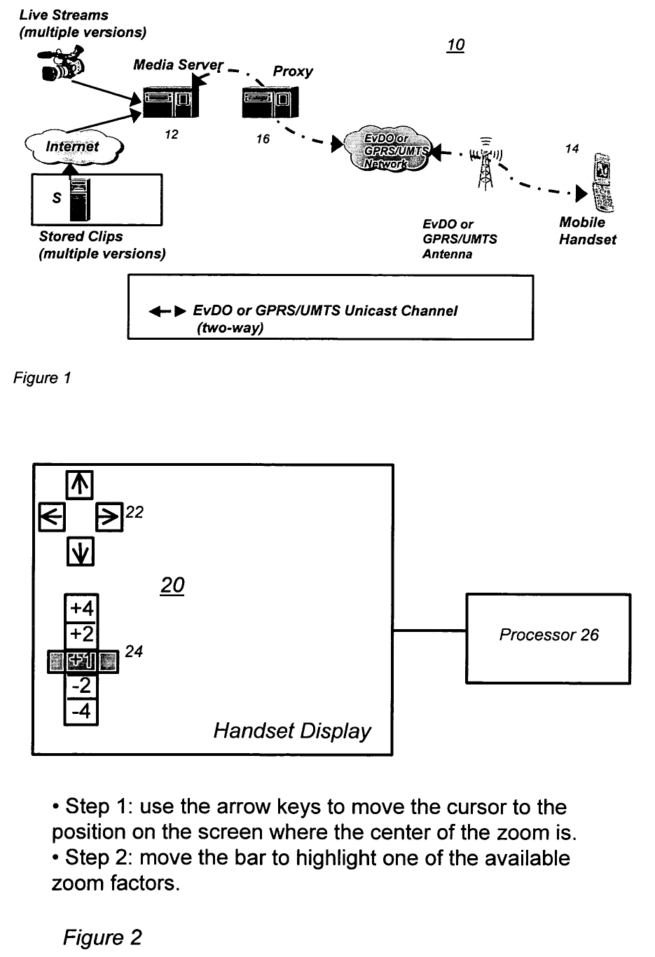

Referring to FIG. 1, an illustration of an exemplary communications network 10 capable of transmitting video services to a wireless communications device is shown. In such a network, video services are typically delivered by way of a client-server architecture, where video programming stored on a server device 12 is transmitted to a wireless end device 14 subscribing to video services and capable of running those services. In the client-server architecture, the RTSP control protocol runs between the video client running on the end device 14 and the video server 12.

In order to operate the zooming feature of the present invention, a new suite of commands will be added to the RTSP protocol. The information in the commands sent from the end user to the video server would include the center of a new view expressed in (x,y) coordinates of the current view, and an indication of the resolution of the new view. It would be understood that other reference points besides the center coordinates and that other coordinate systems may also be used to express a reference upon which a new view will be based, such as for example a corner coordinate

The resolution indication can be expressed, for example, as +2, +4 for zooming in, and −2, −4 for zooming out. We call this number a “zoom factor”. Two versions of the zoom factor, “relative” and “absolute” will be explained, although like methodologies for expressing a desired resolution are contemplated within the scope of the invention. In accordance with the invention, an absolute zoom factor having a value of (1) specifies the default resolution. An absolute zoom factor value of (+2), for example, corresponds to a two times (2×) increase in the default resolution, whereas an absolute zoom factor value of (−2) corresponds to a one half (½×) times the default resolution. Another manner to express resolution in accordance with the invention is to use the notion of “relative zoom factor”, where a value (1) specifies the current resolution and other zoom are based off the current view. When the “relative zoom factor” is used, values that are transmitted in the RTSP protocol would need to be translated to the “absolute zoom factor” when received at the video server as would be understood by those persons skilled in the art.

In order for the video server to respond to the end user's zooming request, multiple versions of the video stream need to be stored at the server. Each version of the stream has a different resolution. When a zoom-in request is received, the video server identifies a version of the stream with higher resolution, and sends back a portion of the stream that covers the smaller requested area. When a zoom-out request is received, the video server needs to identify a version of the stream with lower resolution, and sends back a portion of the stream that covers the larger requested area.

Note that in certain embodiments of the invention, the video display client on the end device and the video server or proxy are synchronized in the sense that the client can only request zoom factors offered by the video server. In the following example, we assume the video server stores the following 5 versions of the stream: 4×resolution, 2× resolution, 1× resolution, (½)×resolution and (¼)× resolution. We also assume the client can only send requests with the following values for the zoom factor: +4, +1, −2, −4. In this case, there is a one-to-one mapping between the zoom factor and different versions of the stream. Each zoom request will be mapped to a particular version of the stream. A request with absolute zoom factor value of 4 will be served with the stream of 4× resolution, a request with absolute zoom factor value of −2 will be served with the stream of (½)×resolution, and so on. However, in the case where the client and the server are not synchronized, a zoom request may not match the available versions of the stream at the server. In order for users to view what they have requested using the zoom feature, we design the GUI on the end device such that the zoom factors available for each stream are clearly specified by the GUI. To satisfy this requirement, a mapping function is provided at both the client and the server to map the client requested zoom factor to the different versions of the stream with different resolution. Implementation of a mapping function as described would be understood by persons skilled in the art.

Another design option is to map different values of zoom factor to one version of the stream. Because we keep the size of the video display the same, this mechanism will, however, produce lower quality images for the zoom-in request, and produce higher quality image for the zoom-out request.

Because the zooming action in most cases still results in the same frame size with the same video quality, the bandwidth required for the stream does not change. In the following exemplary illustration of the present invention, an original video stream requires 100 Kbps of bandwidth, a high resolution version of the same content has 400 Kbps of bandwidth, for example. When a zoom-in command is issued on the original stream to cover only 1/4 of the area, the resulting high-resolution stream still requires 100 Kbps. Therefore, the bandwidth requirement between different zooming requests is not changed. As would be understood, the above statements regarding bandwidth are only an estimate. The exact bandwidth of different video streams vary depending on the image and the compression schemes. Accordingly, stated roughly, a stream with A times resolution will result in A times bandwidth requirement.

The present invention may also be utilized in connection with a client-proxy-server architecture. In such an environment, the zooming command may be handled by a proxy device 16 (shown in FIG. 1) when, for example, multiple versions of the same stream are stored on the proxy. In this setting, the proxy 16 would intercept all the control messages including the zooming command and act accordingly.

The current RTSP protocol does not support a zooming command. The protocol can be easily updated with a new command, however, such as “Zoom”. An exemplary embodiment of the command would contain the following fields:

Zoom-in or Zoom-out

Zooming factor

(x,y) coordinate to center the new stream.

Note that if the (x,y) coordinate is near the edge of the original frame, then it is likely that the entire display window will not be filled, since there is no data beyond the boarder of the original frame regardless which version of the stream it is. Accordingly in one embodiment of the invention, the (x,y) coordinate would be automatically translated by the programming code associated with the zoom feature so as to enable display of a full screen.

Referring to FIG. 2, a GUI 20 may be utilized in order to capture information input from the user and translate the user input into the corresponding RTSP commands. As shown, the GUI includes a “zoom” command, which is accessible from a menu, for example. Once activated, the command would prompt the user for a center point from which the next stream would be referenced. This coordinate may be entered using the directional cursors 22. The next step in the zooming command would be to enter the zoom-in or zoom-out factor utilizing a zoom factor scale 24 for example. As would be understood, each of the steps for the zoom command operation may be entered via the GUI or via hard or soft keys on the telephone keypad or a combination of both. The GUI is operated via programming code stored in memory of the end device and run on a processor 26, as would be understood.

The new zooming feature of the present invention applies to video service on mobile phones. The feature offers more interaction between the end user and the video server and it provides more interesting viewing. It has the potential to become a service differentiator for video services provided by wireless service providers. Because the bandwidth required for the streams does not change, the only complexity incurred is the control message processing, and the only extra storage required is at the video server or the proxy.

Note that this zooming feature for VoD service not only applies to mobile end devices, but also applies to VoD service over the Internet for the wireline “triple play service”. Additionally, the zooming feature not only applies to VoD service for stored content, but also applies to live streams if multiple versions of the stream are generated at the content server.

The foregoing description merely illustrates the principles of the invention. It will thus be appreciated that those skilled in the art will be able to devise various arrangements, which, although not explicitly described or shown herein, embody the principles of the invention, and are included within its spirit and scope. Furthermore, all examples and conditional language recited are principally intended expressly to be only for instructive purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Many other modifications and applications of the principles of the invention will be apparent to those skilled in the art and are contemplated by the teachings herein. Accordingly, the scope of the invention is limited only by the claims.

What is claimed is:

1. A method of providing zooming features to a device capable of displaying streamed TV programming, said method comprising the steps of:
receiving an indication of a reference point for a new view request based on coordinates of a current view of said programming;
receiving an indication of the resolution for said new view;
providing an altered view of said programming to said device based on said received reference point and indicated resolution.

2. The method of claim 1, wherein multiple video streams of differing resolution are available for distribution to said device, further including selecting a stream having a resolution corresponding to said relative resolution of said new view for providing to said mobile device.

3. The method of claim 1, wherein a display window on a mobile device is filled with a stream image in the event that a reference point for a subsequent requested view would fail to fill the display.

4. The method of claim 1, wherein said indication of said reference point and said relative resolution are transmitted as new RTSP commands.

5. The method of claim 2, wherein a higher resolution stream is selected for a zoom-in request and a lower resolution stream is selected for a zoom-out request.

6. The method of claim 5, wherein a relative bandwidth requirement between different zooming requests is maintained from one view to another.

7. The method of claim 4, wherein said reference point is expressed as an (x, y) coordinate.

8. The method of claim 4, wherein said relative resolution is expressed as a positive or negative integer.

9. A method of providing zooming features to a mobile device capable of displaying TV programming, said method comprising:
transmitting an indication of a reference point for a new view request based on coordinates of a current view of said programming;
transmitting an indication of the resolution for said new view;
receiving an altered view of said programming at said mobile device based on said received reference point and indicated resolution.

10. The method of claim 9, wherein multiple video streams of differing resolution are available for distribution to said mobile device, further including receiving a stream having a resolution corresponding to said relative resolution of said new view for providing to said mobile device.

11. The method of claim 9, wherein a display window on said mobile device is filled with a stream image in the event that a reference point for a subsequent requested view would fail to fill the display.

12. The method of claim 9, wherein said indication of said reference point and said relative resolution are transmitted as new RTSP commands.

13. The method of claim 10, wherein a higher resolution stream is selected for a zoom-in request and a lower resolution stream is selected for a zoom-out request.

14. The method of claim 10, wherein a relative bandwidth requirement between different zooming requests is maintained from one view to another.

15. The method of claim 9, wherein a GUI on said mobile phone is utilized to indicate said reference point and said relative resolution.

16. The method of claim 15, wherein said GUI operates using zoom factors selected from the group consisting of absolute and relative zoom factors.

17. The method of claim 15, wherein said GUI is operable to map relative zoom factors entered therein to absolute zoom factors for transmission.

18. A mobile apparatus for providing zooming features related to TV programming being received thereon, said apparatus comprising:
a processor for providing capability to display said TV programming being received; and
a GUI at said mobile apparatus for displaying information related to operation of said zooming features and enabling transmitting information from said mobile apparatus related to said zooming features;
said mobile apparatus operable to transmit an indication of a reference point for a new view request based on coordinates of a current view of said programming; and
further being operable to transmit an indication of the resolution for said new view, wherein said device receives an altered view of said programming based on said received reference point and indicated resolution.

19. The method of claim 18, wherein said indication of said reference point and said relative resolution are transmitted as new RTSP commands.

20. The method of claim 15, wherein said GUI operates using zoom factors selected from the group consisting of absolute and relative zoom factors.
